(19) United States
(12) Patent Application Publication
(10) Pub. No.: US 2015/0369411 A1
(43) Pub. Date: Dec. 24, 2015

(54) PLUMBING ADAPTER COUPLING

(71) Applicant: NIBCO Inc., Elkhart, IN (US)

(72) Inventors: Douglas A. Kieper, Jeffersonville, IN (US); Jordan Rumsey, Louisville, KY (US)

(73) Assignee: NIBCO Inc.

(21) Appl. No.: 14/705,310

(22) Filed: May 6, 2015

Related U.S. Application Data
(60) Provisional application No. 62/015,654, filed on Jun. 23, 2014.

(51) Int. Cl. F16L 33/00; F16L 21/00; F16L 33/30; F16L 19/00

(52) U.S. Cl. CPC F16L 33/006; F16L 19/00; F16L 21/00; F16L 33/30

(57) ABSTRACT

An adapter coupling for coupling PEX tubing to a schedule 40 or schedule 80 fitting has a disk-shaped body with a central axially extending aperture and a PEX tube receiving barbed outlet tube extending outwardly from one side in coaxial relationship to the aperture. The face of the opposite side of the disk-shaped member is smooth to engage a face seal member in a coupling to which the PEX adapter coupling adapter is mounted.

### CROSS-REFERENCE TO RELATED APPLICATIONS

This application claims priority under 35 U.S.C. §119(e) and the benefit of U.S. Provisional Application No. 62/015,654 entitled Plumbing Adapter Coupling, filed on Jun. 23, 2014, by Douglas A. Kieper, et al., the entire disclosure of which is incorporated herein by reference.

### BACKGROUND OF THE INVENTION

The present invention relates to a coupling for adapting standard plumbing fittings and pipes to PEX (cross-linked polyethylene) tubing.

PEX tubing is becoming increasingly popular as a safe, economical, and energy efficient piping alternative for water distribution, radiant floor heating, municipal water supplies, geothermal climate control, snow melt, and drip irrigation. PEX tubing delivers clean and safe potable water and is chlorine resistant, corrosion resistant, freeze-damage and abrasion resistant. The excellent thermal properties of PEX are ideal for hot and cold water distribution. PEX tubings, fittings, valves, and manifolds have been designed to be used as a complete distribution system in both commercial and home applications.

Typically, when used in a distribution system, PEX tubing is coupled to a manifold, which is supplied with water through standard pipe fittings, such as schedule 40 or schedule 80 PVC or CPVC larger diameter supply lines. The PEX tubing can also be coupled directly to the supply line. For providing a lead-free water supply system, threaded lead-free brass adapters have been employed as interface fittings between the PEX tubing and the schedule 40 and 80 fittings. Although this has proved successful, the use of machined lead-free brass fittings is somewhat expensive and typically requires different installation methods.

It would be desirable, therefore, to have a coupling adapter for allowing PEX tubing to be coupled to standard plumbing fittings, such as schedule 40 and 80 fittings and pipes utilizing the same plumbing techniques used in the overall distribution of water with PEX tubing.

### SUMMARY OF THE INVENTION

The present invention relates to an adapter coupling for coupling PEX tubing to a standard plumbing fitting and comprises a disk-shaped body having a central axially extending aperture therethrough with a PEX tube receiving barbed outlet tube extending outwardly from one side in coaxial relationship to said aperture. The face of the opposite side of the disk-shaped body is smooth to engage a face seal member in a coupling to which the PEX adapter coupling adapter is mounted.

In one embodiment, the disk-shaped body is stepped with two different diameter sections to facilitate positioning the PEX adapter coupling in a threaded collar to captively hold the PEX adapter coupling in sealed engagement with a plumbing fitting having a face seal. This results in a sealed interconnection between the fitting and PEX tubing coupled to the PEX adapter coupling. The diameter of the PEX output tube can range from ½″ to 2″ depending upon the PEX tubing employed. The PEX adapter coupling can be any size from ½″ to 2″ and can also be a reduction in size from the incoming supply water pipe. The schedule 40 or schedule 80 incoming water line is typically coupled to a valve of the same size as the water supply line, but the outgoing PEX adapter coupling can be a reduction in size or the same size, as desired. The design of the PEX adapter coupling facilitates installation of PEX tubing in a plumbing system utilizing existing supply conduits and fittings and can be universally used with a variety of fittings.

These and other features, objects and advantages of the present invention will become apparent upon reading the following description thereof together with reference to the accompanying drawings.

### BRIEF DESCRIPTION OF THE DRAWINGS

FIG. 1 is a partially exploded perspective view of a schedule 80 valve and inlet pipe and showing a PEX adapter coupling coupled thereto for coupling PEX tubing to the valve;

FIG. 2 is an exploded perspective view of the valve and PEX adapter coupling shown in FIG. 1;

FIG. 3 is an end view of the valve and PEX adapter coupling shown in FIG. 1, showing the O-ring seal of the valve and a sealing face surface of the PEX adapter coupling;

FIG. 4 is a partially exploded perspective view of a union coupled to a schedule 80 pipe and a PEX adapter coupling allowing the coupling of PEX tubing to a schedule 80 pipe;

FIG. 5 is an exploded perspective view of the union and PEX adapter coupling of FIG. 4 shown in a disassembled state;

FIG. 6 is a right-end perspective view of the assembled union shown in FIG. 4;

FIG. 7 is a perspective view of the inlet end of a PEX adapter coupling;

FIG. 8 is a side elevational view of the structure shown in FIG. 7;

FIG. 9 is a perspective view of the outlet end of a PEX adapter coupling for PEX tubing of a first dimension;

FIG. 10 is a perspective view of the inlet end of a PEX adapter coupling for use with PEX tubing having a larger diameter than that for use with a PEX adapter coupling shown in FIG. 7;

FIG. 11 is a side elevational view of the PEX adapter coupling shown in FIG. 10; and

FIG. 12 is a perspective view of the outlet end of the PEX adapter coupling for PEX tubing of a larger diameter.

### DETAILED DESCRIPTION OF THE PREFERRED EMBODIMENT

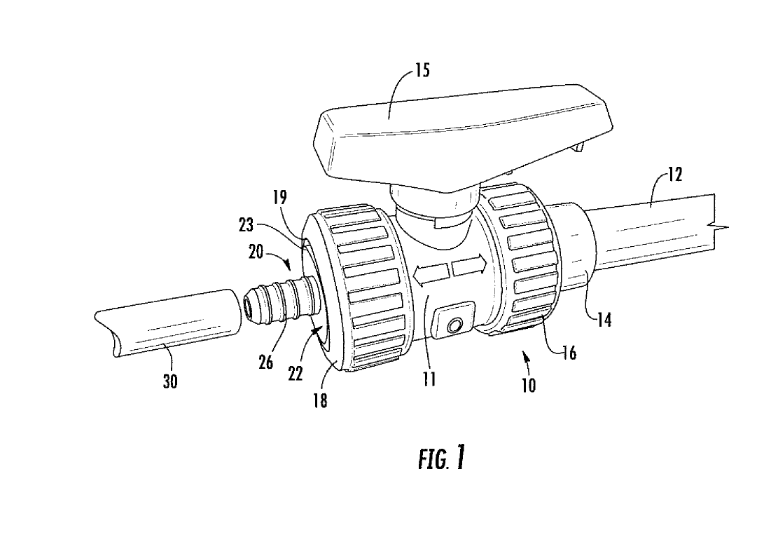

Referring initially to FIGS. 1-3, there is shown a polymeric valve 10 which is coupled to an input supply conduit 12, which can be from a 6″ to a ½″ schedule 40 or schedule 80 PVC conduit that is cemented into the input collar 14 of valve 10 in a conventional manner. The valve illustrated is a ½″ valve. Input collar 14 is sealably coupled to a face seal on the threaded body 11 of valve 10 by a threaded collar 16. The opposite end of valve 10 includes a PEX adapter coupling 20 embodying the present invention for attaching PEX tubing 30 to the valve which selectively supplies water from the schedule 80 conduit to the PEX conduit 30 without exposure to lead contamination.

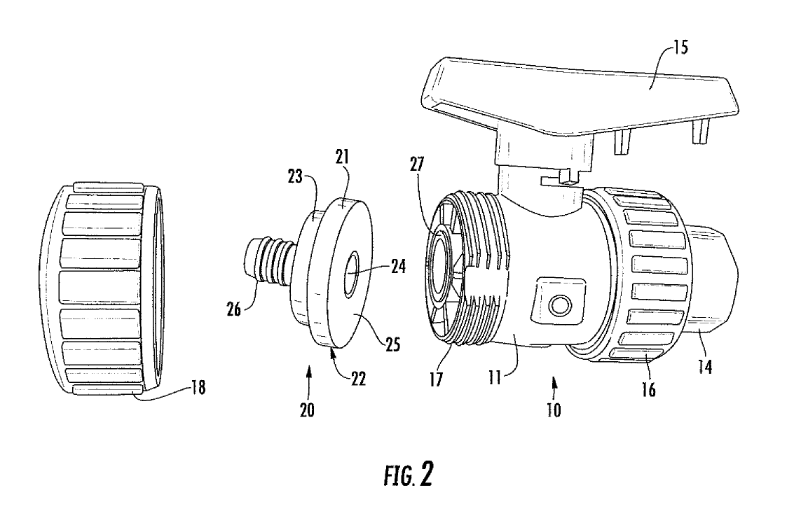

The PEX adapter coupling 20 comprises a disk-shaped body 22 (FIG. 2) having a central aperture 24 extending therethrough and communicating with a barbed output PEX receiving tube 26 on one side which is coaxially aligned with aperture 24. The PEX adapter coupling 20 preferably has a stepped diameter body 22 with a first section 21 substantially conforming to the outer diameter of the output end 17 of valve 10 and a reduced diameter section 23 which extends through the central opening 19 (FIG. 1) of threaded collar 18 to facilitate centering the connector with respect to collar 18 and valve end 17. Side 25 opposite tube 26 of the PEX adapter coupling is smooth to sealably engage an O-ring face seal 27 (FIG. 2) on valve 10 when collar 18 secures the PEX adapter coupling 20 to valve 10. Valve 10 is a ball valve conventionally controlled by a handle 15. PEX conduit 30 is sealably coupled to barbed tube 26 of PEX adapter coupling 20 by pushing the PEX conduit over tube 26 and crimping a ring over the overlapping end of conduit 30 with tube 26 using a standard crimping tool and ring.

The PEX adapter coupling can be integrally molded of a polymeric material, such as polysulfone, PVC, or CPVC. In some installations, it may be desirable to use metal, such as lead-free copper, bronze, or stainless steel. The dimensions of the disk-shaped sections 21, 23 will be varied to fit any sized mating plumbing fitting with which the PEX adapter coupling will be used. Similarly, the diameter of the barbed PEX receiving tube 26 will be selected to receive the PEX tubing diameter employed in a given installation.

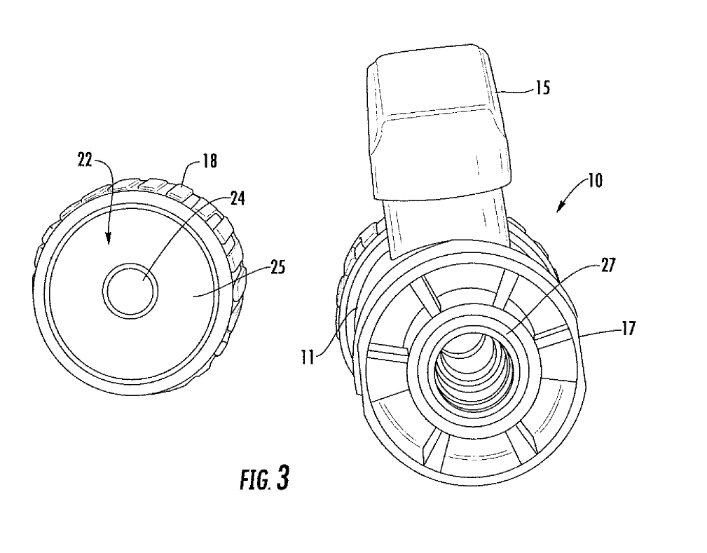

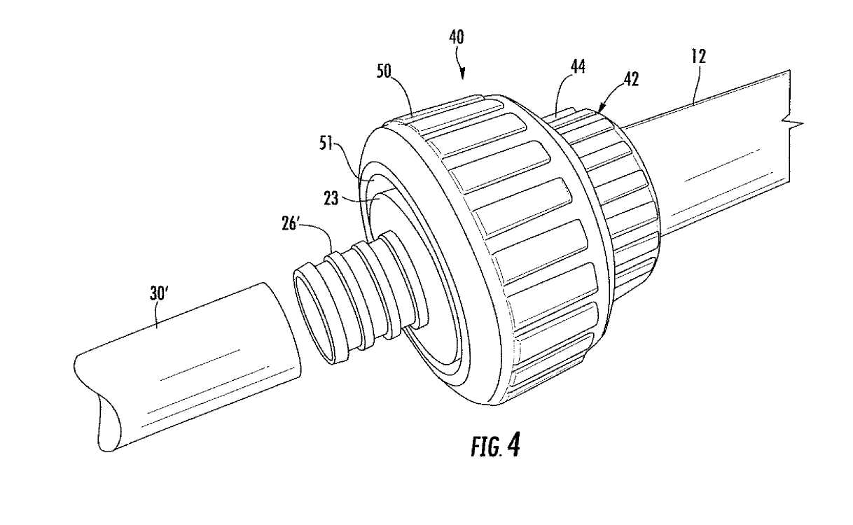

Referring now to FIGS. 4-6, there is shown another schedule 80 fitting, namely, a union 40 having a body 42 (FIG. 5) with an input collar 44. Input collar 44 receives the supply conduit 12, such as in the first embodiment, which is cemented to a conventional socket 43 (FIG. 6) within the input collar 44 to sealably and physically secure the conduit 12 to the union 40. Body 42 is threaded at 46, as seen in FIG. 5, and includes an O-ring face seal 48 for sealably engaging the smooth sealing surface 25 of the disk-shaped PEX adapter coupling 20. PEX adapter coupling 20 is of the same construction as PEX adapter coupling 20 in the FIGS. 1-3 embodiment but has a barbed output tube 26′ having a diameter larger than that of the first embodiment to receive a larger diameter PEX tube 30′. The union has a central opening 41 (FIG. 5) communicating with the conduit 12 and coaxially aligned with the central opening 24 of PEX adapter coupling 20. An internally threaded collar 50 includes an opening 51 through which the reduced diameter section 23 of PEX adapter coupling 20 extends, as seen in FIG. 4, when the threaded collar 50 sealably secures the PEX adapter coupling 20 to the body 42 of union 40. As in the first embodiment, the PEX tube 30′ is pushed over the barbed tube 26′ extending from a side of the body of PEX adapter coupling 20 opposite the sealing surface 25, and a crimping band is placed over the end of PEX tube 30′ overlapping barbed end 26′ to sealably and mechanically couple the PEX tube to the union.

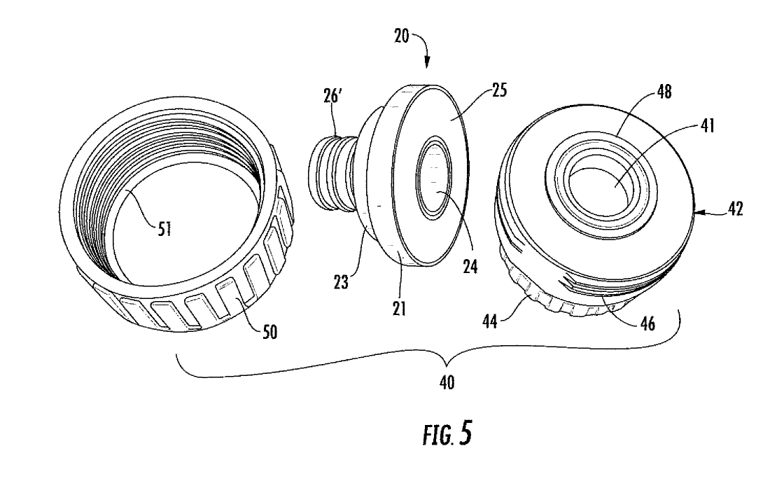

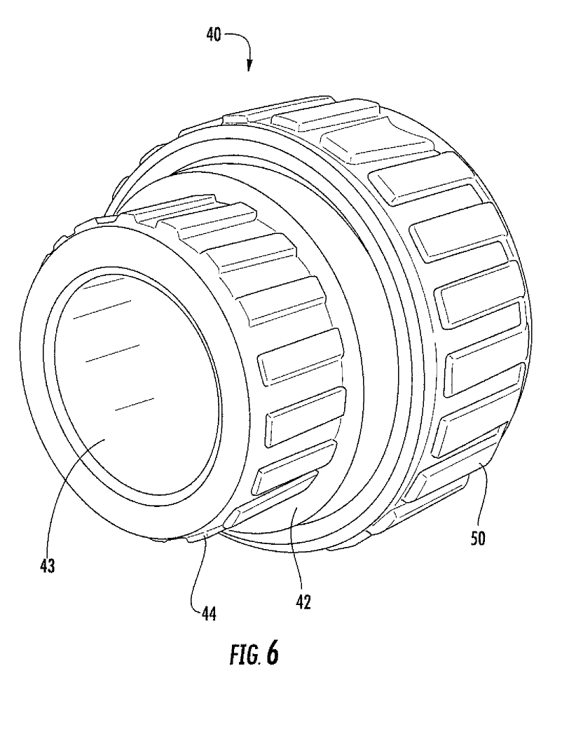

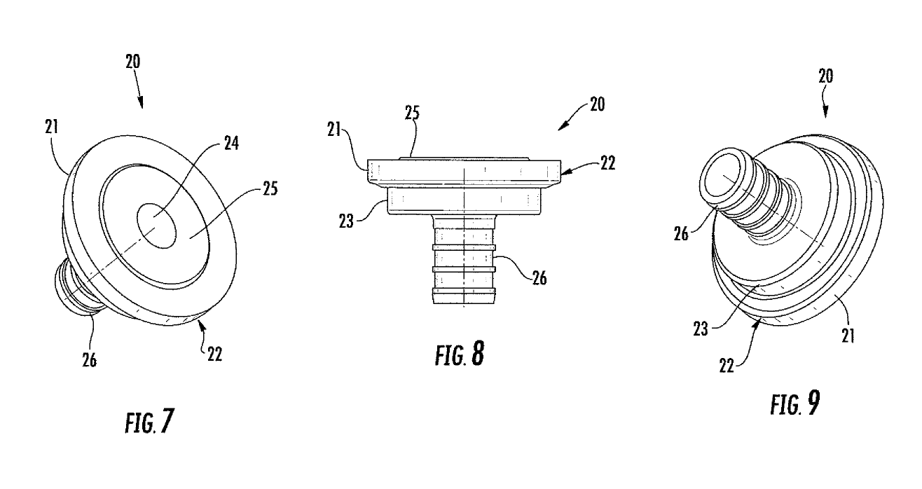

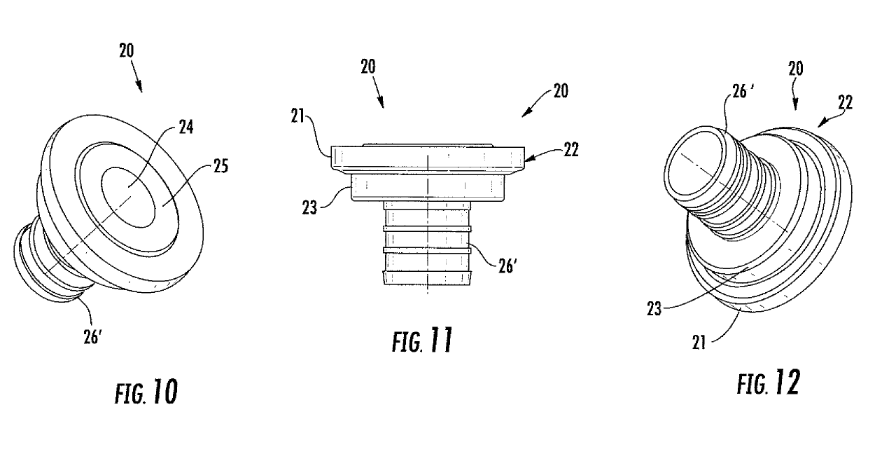

FIGS. 7-9 are detailed drawings showing the smaller diameter PEX adapter coupling 20, shown in FIGS. 1-3, while FIGS. 11-13 are detailed drawings of the larger PEX adapter coupling 20, shown in FIGS. 4-7. Although this invention solves a unique problem with adapting PEX tubing to standard fittings, such as schedule 40 and schedule 80 fittings, it may have application in other plumbing systems.

It will become apparent to those skilled in the art that various modifications to the preferred embodiment of the invention as described herein can be made without departing from the spirit or scope of the invention as defined by the appended claims.

The invention claimed is:

1. A PEX adapter coupling for coupling PEX tubing to standard pipe fittings, said PEX adapter coupling comprising:
a disk-shaped body having a central aperture;
an integrally formed barbed outlet tube extending from one side of said body in coaxial relationship to said aperture; and
said disk-shaped body having a side opposite said barbed outlet tube with a smooth surface for forming a face seal to a ring seal of a pipe fitting.

2. The PEX adapter coupling as defined in claim 1 wherein said disk-shaped body is stepped with two different diameter sections.

3. The PEX adapter coupling as defined in claim 2 wherein said outlet tube includes a plurality of spaced-apart outwardly extending barbs for securing a PEX tube to said outlet tube.

4. The PEX adapter coupling as defined in claim 3 wherein said PEX adapter coupling is made from one of polysulfone, PVC and CPVC.

5. The PEX adapter coupling as defined in claim 3 wherein said PEX adapter coupling is made from one of copper, brass and stainless steel.

6. A plumbing connection for coupling PEX tubing to a plumbing fitting comprising:
a valve having a body with an input end and an output end, wherein said output end includes a face seal;
a supply conduit coupled in sealed engagement to said input end of said valve;
a PEX adapter coupling having a disk-shaped body with a circular sealing surface coupled to said face seal of said output end of said valve, said PEX adapter coupling having a central aperture and an integrally formed barbed outlet tube extending from a side of said body opposite said circular sealing surface in coaxial relationship to said aperture; and
a collar for securing said PEX adapter coupling to said output end of said valve.

7. The plumbing connection as defined in claim 6 and further including a PEX tube coupled to said outlet tube of said PEX adapter coupling.

8. The plumbing connection as defined in claim 6 wherein said disk-shaped body is stepped with two different diameter sections.

9. The plumbing connection as defined in claim 8 wherein one of said different diameter sections is smaller and extends through an opening in said collar.

10. The plumbing connection as defined in claim 9 wherein said outlet tube includes a plurality of spaced-apart outwardly extending barbs for securing a PEX tube to said outlet tube.

11. The plumbing connection as defined in claim 10 wherein said PEX adapter coupling is made from one of polysulfone, PVC and CPVC.

12. The plumbing connection as defined in claim 10 wherein said PEX adapter coupling is made from one of copper, brass and stainless steel.

13. The plumbing connection as defined in claim 6 wherein said fitting is one of a schedule 40 and schedule 80 fitting.

14. A plumbing connection for coupling PEX tubing to a plumbing fitting comprising:
a union having a body with an input end and an output end, wherein said output end includes a face seal;
a supply conduit coupled in sealed engagement to said input end of said union;
a PEX adapter coupling having a disk-shaped body with a circular sealing surface coupled to said face seal of said output end of said union, said PEX adapter coupling having a central aperture and an integrally formed barbed outlet tube extending from a side of said body opposite said circular sealing surface in coaxial relationship to said aperture; and
a collar for securing said PEX adapter coupling to said output end of said union.

15. The plumbing connection as defined in claim 14 and further including a PEX tube coupled to said outlet tube of said PEX adapter coupling.

16. The plumbing connection as defined in claim 14 wherein said disk-shaped body is stepped with two different diameter sections.

17. The plumbing connection as defined in claim 14 wherein one of said different diameter sections is smaller and extends through an opening in said collar.

18. The plumbing connection as defined in claim 15 wherein said outlet tube includes a plurality of spaced-apart outwardly extending barbs for securing a PEX tube to said outlet tube.

19. The plumbing connection as defined in claim 14 wherein said PEX adapter coupling is made from one of polysulfone, PVC and CPVC.

20. The plumbing connection as defined in claim 14 wherein said PEX adapter coupling is made from one of copper, brass and stainless steel.

21. The plumbing connection as defined in claim 14 wherein said fitting is one of a schedule 40 and schedule 80 fitting.
